(19) United States
(12) Patent Application Publication
(10) Pub. No.: US 2002/0152219 A1
(43) Pub. Date: Oct. 17, 2002

(54) Data interexchange protocol

(76) Inventor: Monmohan L. Singh, Phoenix, AZ (US)

Correspondence Address: The Halvorson Law Firm, Ste 1, 405 W. Southern Ave., Tempe, AZ, 85282, US

(21) Appl. No.: 09/775,913

(22) Filed: Apr. 16, 2001

(51) Int. Cl. G06F 7/00

(52) U.S. Cl. 707/101

(57) ABSTRACT

A method of efficient compression, storage, and transmission is presented that takes advantage of the fact that most of the text manipulated by distributed information systems is written in natural languages comprised of a finite vocabulary of words, phrases, sentences, and the like. The method achieves significant efficiencies over prior art by using a hierarchy of dictionaries or vocabularies that are dynamically created and may contain subdictionaries that are specific to the national language (such as English and/or German) and possibly the subject area (such as medical, legal or computer science) of the textual information being encoded, stored, searched, and transmitted. This method is also applicable to non-natural language files, i.e., binary files, exec files, and the like. The method includes steps of parsing words or data sequences from text in an input file and comparing the parsed words or data sequences to the dynamically compiled hierarchical dictionaries. The dictionaries have a plurality of vocabulary words in it and numbers or tokens corresponding to each vocabulary word. A further step is determining which of the parsed words or data bit chunk of varying lengths are not present in the predetermined dictionary and creating at least one supplemental dictionary including the parsed words that are not present in the predetermined dictionary. The predetermined dictionary and the supplemental dictionary are stored together in a file that may be compressed. Also, the parsed words are replaced with numbers or tokens corresponding to the numbers assigned in the predetermined and supplemental dictionary and the numbers or tokens are stored in the compressed file.

### FIELD OF THE INVENTION

The present invention relates to a method for efficient data compression of a plurality of documents that may be used, for example, to reduce the space required by data for storage in a mass storage device such as a hard disk, or to reduce the bandwidth required to transmit data. More specifically, the present invention relates to a method for data compression that utilizes the distributed nature of a world-wide computer network to compile and maintain a dynamic compression dictionary used for the efficient data compression of electronic documents.

### BACKGROUND ART

The amount of data being transmitted electronically over distributed computer networks, such as the Internet, is ever increasing. The data may be transmitted electronically in any language, may have been generated using any type of program, may or may not be in a format that can be executed by a computer, may be uncompressed or compressed using any type of compression scheme, and so on.

In distributed linked file systems like the worldwide web on the Internet, there is frequently a need to store large amounts of information written in natural languages, such as English, as plain text in server systems and/or then to transmit that text information to other server or client systems efficiently. Additionally, there is a requirement to quickly and efficiently perform full-text searches on all or part of the material stored either in client or server computers. These requirements exist not only in hypertext systems like the worldwide web of computers on the internet, but also in distributed information query and retrieval systems or in database systems that accommodate storage of long text streams. Present methods of data compression that operate uniformly on all binary stored information are not necessarily well suited to supporting these long text streams both in terms of compression and decompression efficiency.

There are a number of conventional compression schemes, for example the compression scheme disclosed in U.S. Pat. No. 5,099,426 to Carlgren et al., which is hereby incorporated by reference herein. While conventional systems such as that disclosed in Carlgren use word tokenization schemes for compression, they suffer from several inefficiencies that make them less suitable for distributed systems use. In conventional systems, tokens (word numbers) assigned to each unique word in the text are determined by processing the specific text to be encoded and developing a table that ranks the words by frequency of occurrence in the text. This document specific ranking is then used to assign the shortest tokens (typically 1-byte) to words having the highest frequency of occurrence and to assign longer tokens to the less frequently occurring words.

While conventional encoding achieves a high degree of compression it creates several other inefficiencies, particularly in a distributed hypertext system like the worldwide web. First, each document has its own unique encoding for each word. Thus, in one document the word “house” might be assigned a numeric value of 103, and in another document the word “house” might be assigned the number 31464. This document specific tokenization means that a unique table or vocabulary must be maintained as part of each document that maps the tokens assigned to data sequences. Second, a vocabulary table must be stored with the compressed text and must be transmitted with compressed text to any processor (client or server) that will further store, search or decompress the document. Third, when such a frequency table is used as the primary mechanism for determining the encoding of tokens in the compressed text, the assignment of tokens to words is so tightly optimized to the frequency distribution of words in the particular encoded document that when the existing text needs to be updated by even a few words or phrases the entire encoding scheme must be redone to accommodate any new strings that may be present. Fourth, in order to encode strings of characters that do not constitute natural language words, the strings are assigned their own unique tokens. Examples of such character strings are numeric values, codes, table framing characters, or other character-based diagrams. While conventional compression methods may be acceptable when documents contain only a small number of such strings, the encoding scheme can break down if the document requires representation of larger numbers of such strings. Examples of documents that might be difficult to encode are those that contain scientific or financial tables that have many unique numbers. Fifth, the close optimization of token assignment to word frequency may be complicated with documents that contain large numbers of unique words. Examples of these kinds of document include dictionaries, thesauri, and technical material containing tables of chemical, drug, or astronomical names. Lastly, conventional compression techniques do not easily accommodate documents that include text from more than one national natural language, such as for example a translated document that includes both U.S. English and International French.

Data sequences are used widely in computer processing fields, as many computer applications involve the creation and manipulation of structured data. In database systems, there will be a database server computer arranged to manage the data within the database. Client computers are connected to the server computer via a network in order to transmit data among the different computers. The server then processes queries and passes the results back to the client. The results generally take the form of a structured data sequence having a plurality of records, and each record having a plurality of fields with data items stored therein. For example, in a database containing details of a company's employees would typically have a data record for each employee. Each such data record would have a number of fields for storing data such as name, age, sex, job description, etc. Within each field, there will be stored a data item specific to the individual, for example, Mr. Smith, 37, Male, Sales executive, etc. Hence a query performed on that database will generally result in a data sequence being returned to the client which contains a number of records, one for each employee meeting the requirements of the database query.

Since data storage is expensive, it is clearly desirable to minimize the amount of storage required to store structured data. Additionally, when a data sequence is copied or transferred between storage locations, it is desirable to minimize the overhead in terms of CPU cycles, network usage, etc. within the database field, therefore much research has been carried out in to techniques for efficiently maintaining copies of data. Generally, these techniques are referred to as ‘data replication’ techniques. The act of making a copy of data may result in a large sequence of data being transferred from a source to a target, which is typically very costly in terms of CPU cycles, network usage, etc. within the database arena. This ‘data replication’ is often a repeated process with the copies being made at frequent intervals. Hence, the overhead involved in making each copy is an important issue, and it is clearly advantageous to minimize such overhead.

To reduce the volume of data needing to be transferred and the time required to copy a set of data, an area of database technology called ‘change propagation’ has been developed. Change propagation involves identifying the changes to one copy of a set of data, and to only forward those changes to the locations where other copies of that data set are stored. For example, if on Monday system B establishes a complete copy of a particular data set stored on system A, then on Tuesday it will only be necessary to send system B a copy of the changes made to the original data set stored on system A since the time on Monday that the copy was made. By such an approach, a copy can be maintained without the need for a full refresh of the entire data set. However, even when employing change propagation techniques, the set of changes from one copy to the other may be quite large, and hence the cost may still be significant.

Other techniques have been developed. For example U.S. Pat. No. 5,418,951, entitled “METHOD OF RETRIEVING DOCUMENTS THAT CONCERN THE SAME TOPIC,” discloses a method of using an n-gram of a certain fixed length to characterize received data and known data. The commonality between the various files is then removed to further refine the characterization of each file. The refined characterization of the received file is then compared to the stored files to determine which of the stored files the received file is most similar to. Beyond the removal of commonality, U.S. Pat. No. 5,418,951 does not attempt to further distinguish any data files from one another as does the present invention. Furthermore, U.S. Pat. No. 5,418,951 results in one similarity determination and does not make multiple determinations, as does the present invention. U.S. Pat. No. 5,418,951 is hereby incorporated by reference into the specification of the present invention.

Another example is U.S. Pat. No. 5,463,773, entitled “BUILDING OF A DOCUMENT CLASSIFICATION TREE BY RECURSIVE OPTIMIZATION OF KEYWORD SELECTION FUNCTION,” which discloses a method of classifying documents based on keyword selection. The document classification method of U.S. Pat. No. 5,463,773 may not be optimal if received documents are in different languages. Also, this method based on keywords may not work properly on nontextual data, compressed files, or executable code. U.S. Pat. No. 5,463,773 is hereby incorporated by reference into the specification of the present invention.

U.S. Pat. No. 5,526,443, entitled “METHOD AND APPARATUS FOR HIGHLIGHTING AND CATEGORIZING DOCUMENTS USING CODED WORD TOKENS,” discloses a device for and a method of identifying the topic of a received document by converting the words in a received document to abstract coded character token. Certain tokens are then removed based on a list of stop tokens. Numbers are included on the stop token list classifying documents based on keyword selection. The topic identification method of U.S. Pat. No. 5,526,443 may not be optimal for processing compressed documents, executable code, or nontextual documents as can the present invention which does not use tokens or previously constructed stop lists. U.S. Pat. No. 5,526,443 is hereby incorporated by reference into the specification of the present invention.

U.S. Pat. No. 5,706,365, entitled “SYSTEM AND METHOD FOR PORTABLE DOCUMENT INDEXING USING N-GRAM WORD DECOMPOSITION,” discloses a device for and a method of identifying documents that contain the n-grams of a natural language search query that has been parsed into a list of fixed length n-grams. The document retrieval method of U.S. Pat. No. 5,706,365 is not a method of identifying the type of data in an electronic file using n-grams as is the present invention, but a method of using n-grams to locate other documents that contain those n-grams. 5,548,507 is hereby incorporated by reference into the specification of the present invention.

U.S. Pat. No. 5,717,914, entitled “METHOD FOR CATEGORIZING DOCUMENTS INTO SUBJECTS USING RELEVANCE NORMALIZATION FOR DOCUMENTS RETRIEVED FROM AN INFORMATION RETRIEVAL SYSTEM IN RESPONSE TO A QUERY,” discloses a method of storing a received document into a database having a plurality of document classes. Each received document is compared against a preconceived word list that is representative of one of the possible classes in the database. The class of the word list that compares most favorably to the received document is the class that the received document will be stored in. The storage method of U.S. Pat. No. 5,717,914 may not be optimal for processing compressed documents, executable code, or non-textual documents for which it may be impossible to generate a preconceived word list. The present invention can identify these types of data without having to generate a preconceived word list. U.S. Pat. No. 5,717,914 is hereby incorporated by reference into the specification of the present invention.

The present invention is particularly concerned with data compression systems using dynamically compiled hierarchical dictionaries. In such systems, an input data stream is compared with strings stored in a dictionary. When characters from the data stream have been matched to a byte chunk of varying length in the dictionary, the code for that byte chunk of varying length is read from the dictionary and transmitted in place of the original characters. At the same time when the input data stream is found to have character sequences not previously encountered and so not stored in the dictionary then the dictionary may be updated by making a new entry and assigning a code to the newly encountered character sequence. This process is duplicated on the transmission and reception sides of the compression system. The dictionary entry is commonly made by storing a pointer to a previously encountered byte chunk of varying length together with the additional character of the newly encountered byte chunk of varying length.

### SUMMARY OF THE INVENTION

A method of efficient compression, storage, and transmission according to the present invention takes advantage of the fact that most of the text manipulated by distributed information systems is, in fact, written in natural languages comprised of a finite vocabulary of words, phrases, sentences, and the like. For example, in a common U.S. English business communication it is normal to find that a vocabulary of under 2000 general words, augmented by about 100-200 special terms that are specific to the type of business being discussed, generally serves adequately.

The method according to the present invention achieves significant efficiencies over prior art by using a hierarchy of dictionaries or vocabularies that are dynamically created and may contain subdictionaries that are specific to the national language (such as English and/or German) and possibly the subject area (such as Medical, Legal or Computer Science) of the textual information being encoded, stored, searched, and transmitted. This method, however, is also applicable to non-natural language files, i.e., binary files, exec files, and the like.

The method includes steps of parsing words or data sequences from text in an input file and comparing the parsed words or data sequences to the dynamically compiled hierarchical dictionaries. The dictionaries have a plurality of vocabulary words in it and numbers or tokens corresponding to each vocabulary word. A further step is determining which of the parsed words or data byte chunk of varying lengths are not present in the predetermined dictionary and creating at least one supplemental dictionary including the parsed words that are not present in the predetermined dictionary. The predetermined dictionary and the supplemental dictionary are stored together in a file that may be compressed. Also, the parsed words are replaced with numbers or tokens corresponding to the numbers assigned in the predetermined and supplemental dictionary and the numbers or tokens are stored in the compressed file.

According to a first aspect of the present invention there is provided a data compression system including at least one dictionary to store byte chunks of varying lengths with an index for each of said byte chunk of varying length, and means for matching the byte chunk of varying length in a data stream with a byte chunk of varying length stored in the dictionary and for outputting the identity of a dictionary entry of a matched byte chunk of varying length when a following character of the data stream does not match with the stored byte chunk of varying length. This is especially characterized in that the means for matching the byte chunks of varying lengths is arranged to determine, for each matched byte chunk of varying length having at least three characters, a sequence of characters from the at least three characters, the sequence including at least a first and a second of said at least three characters, to update the dictionary by extending an immediately-preceding matched byte chunk of varying length by the sequence.

According to a second aspect there is provided a method of data compression of individual sequences of characters in a data stream including the steps of storing byte chunk of varying lengths in a dictionary with an index for each of said byte chunk of varying lengths, and determining the longest byte chunk of varying length in the dictionary which matches a current byte chunk of varying length in the data stream starting from a current input position: the improvement including the steps of determining, for each matched byte chunk of varying length having at least three characters, a single sequence of characters from the said at least three characters, the single sequence including at least a first and a second of the at least three characters, but not including all of the at least three characters, and updating the dictionary by extending an immediately-preceding matched byte chunk of varying length by the single sequence.

In known systems, dictionary entries are made either by combining the single unmatched character left over by the process of searching for the longest byte chunk of varying length match with the preceding matched byte chunk of varying length or by making entries comprising pairs of matched byte chunks of varying lengths. The former is exemplified by the Ziv Lempel algorithm (“Compression of Individual Sequences via Variable Rate Coding,” J. Ziv, A. Lempel, IEEE Trans, IT 24.5, pp. 530-36, 1978), the latter by the conventional Mayne algorithm (Information Compression by Factorizing Common Strings,“A. Mayne, E. B. James, Computer Journal, vol. 18.2, pp. 157-60, 1975), and EP-A-012815, Miller and Wegman, discloses both methods.

Given the above problems, it is an object of the present invention to provide a technique for compressing structured data that will alleviate some of the cost of maintaining and replicating structured data. One embodiment of the present invention is described in detail and contrasted with the prior art in the following technical description.

The novel features that are considered characteristic of the invention are set forth with particularity in the appended claims. The invention itself, however, both as to its structure and its operation together with the additional object and advantages thereof will best be understood from the following description of the preferred embodiment of the present invention when read in conjunction with the accompanying drawings. Unless specifically noted, it is intended that the words and phrases in the specification and claims be given the ordinary and accustomed meaning to those of ordinary skill in the applicable art or arts. If any other meaning is intended, the specification will specifically state that a special meaning is being applied to a word or phrase. Likewise, the use of the words “function” or “means” in the Description of Preferred Embodiments is not intended to indicate a desire to invoke the special provision of 35 U.S.C. §112, paragraph 6 to define the invention. To the contrary, if the provisions of 35 U.S.C. §112, paragraph 6, are sought to be invoked to define the invention(s), the claims will specifically state the phrases “means for” or “step for” and a fimction, without also reciting in such phrases any structure, material, or act in support of the function. Even when the claims recite a “means for”or “step for” performing a finction, if they also recite any structure, material or acts in support of that means of step, then the intention is not to invoke the provisions of 35 U.S.C. §112, paragraph 6. Moreover, even if the provisions of 35 U.S.C. §112, paragraph 6, are invoked to define the inventions, it is intended that the inventions not be limited only to the specific structure, material or acts that are described in the preferred embodiments, but in addition, include any and all structures, materials or acts that perform the claimed function, along with any and all known or later-developed equivalent structures, materials or acts for performing the claimed function.

### BRIEF DESCRIPTION OF THE DRAWINGS

FIG. 1 is a block schematic diagram of a data compression system of the present invention;

FIG. 2 is a tree representative of a number of dictionaries and dictionary entries in a dictionary structured in accordance with the prior art.

### DESCRIPTION OF THE PREFERRED EMBODIMENT

By way of background to the present invention it is convenient first to refer to known prior art data compression systems. The Mayne algorithm (1975) predates the Ziv Lempel algorithm by several years, and has a number of features which were not built in to the Ziv Lempel implementations until the 1980's. The Mayne algorithm is a two pass adaptive compression scheme.

As with the Ziv Lempel algorithm, the Mayne algorithm represents a sequence of input symbols by a codeword. This is accomplished using a dictionary of known byte chunks of varying lengths, each entry in the dictionary having a corresponding index number or codeword. The encoder matches the longest byte chunk of varying length input symbols with a dictionary entry, and transmits the index number of the dictionary entry. The decoder receives the index number, looks up the entry in its dictionary, and recovers the corresponding byte chunk of varying length.

Most compression schemes build a dictionary of words and then replaces word occurrences in documents with tokens. The software of the present invention searches the document for common occurrences of byte chunks of varying lengths and creates a dictionary table at the beginning of the file. This is because building a dictionary larger than 64K is inefficient in terms of reconstruction and also in terms of cycles. As the size of the dictionary increases, the cost of creating the dictionary increases exponentially in terms of CPU power. Eight bytes of map space are an efficient allocation. Thus, most algorithms do not use space allocations larger than eight bytes. In order to create larger storage it is desirable to have more compression. This is accomplished by creating a common global dictionary that contains at least regional subdictionaries and may contain file specific subdictionaries.

A global dictionary is one that is accessible by a plurality of documents and contains the most commonly occurring words and phrases. Regional subdictionaries contain less commonly occurring words and phrases, but may also be accessible by multiple document files. There may be numerous levels of subdictionaries, from the encompassing global dictionary, through a regional subdictionary to a file specific subdictionary. The regional subdictionaries may be general in nature or they may be content specific, i.e., subject matter oriented.

According to the present invention, the global dictionary does not have a predefined number of subdictionaries, but may have N levels. The number of levels is only defined for a specific compression application. That is, you define how many layers of dictionaries you want relative to a specific application. The number of layers depends upon the diversity of data contained within the document file. The more diverse the data, the more layers that may be desired. Alternately, the number of layers may be automatically selected according to the present invention (in order to optimize file compression versus processing time) or it may be user determined.

Currently, compression algorithms compress each separate file individually, without utilizing commonly occurring words and phrases that occur in many documents. It has been found that all of the files that are stored in a storage device usually have certain commonalties, commonly occurring byte chunk of varying lengths. This is true for all types of files, from executables (programs) to document files. The dictionary structure according to the present invention is a dynamically balanced index, or a dynamically balanced hash tree; or it may be considered a multidimensional spherical structure with the most common elements resident in the center of the sphere.

A first file is used to create the original common or global dictionary. It is possible to use a pre-created dictionary, but currently it is preferred to create the global dictionary ab intio. However, it may be more efficient to use a pre-defined dictionary when compressing a large number of files. Surrounding the central or global dictionary are one or more subdictionary layers. In the following discussion, we will refer to a single layer for the sake of simplicity. One of ordinary skill in the arts will recognize that the ideas and concepts found herein may be generalized to numerous levels and multiple subdirectories.

A second file is analyzed and word and byte chunks of varying length structure frequency across the file is compared to the existing global dictionary. The second file“s structure pattern is frequency compared against the existing global dictionary byte patterns to determine if compression can be achieved without creating a new file specific dictionary or adding words/bytes to the existing global dictionary.

The best case is when a new file can be compressed using an existing dictionary. This case is the most economical since it does not involve the creation of a file specific dictionary or additions to existing dictionaries. If the new file cannot be compressed using an existing dictionary, then the dictionary sub-algorithms will look to see if any of the new file's words/bytes matches any previous data file's byte chunk patterns. Any byte chunk matching across data files would then be added to the global dictionary. Any file specific compression byte chunks (byte chunks not found to enhance compression of other data files) would then be used to create a subdictionary specific to the new file. In the example of a single layer of subdictionaries, the new subdictionary would branch directly off of the global dictionary.

Another improvement is that the algorithm may initially make an individual dictionary for a file and only search tokens of the individual dictionary in the global dictionary instead of researching all tokens of the file. The invention discloses both routes as possible manner of achieving compression against a common dictionary. The second method is usually less CPU intensive but possibly less efficient also in compression.

Regional subdictionaries will usually be created within a business since businesses create multiple copies of nearly identical documents, typically with small changes. Fields of business also create regional subdictionaries since there are many commonalties in documents prepared by different entities within the same field of business.

The algorithm according to the present invention routinely scans across subdictionaries to determine whether different subdictionaries have common patterns that can be concentrated upward in the hierarchical dictionary structure. The differences can be stored as two new smaller subdictionaries (pattern deltas). Thus, the algorithm continuously builds and improves multiple dictionary layers.

The dictionary itself can be saved in a multi-generational architecture so that a compressed file points to a specific version/generation of the dictionary and the process of recompression may not occur until one or more newer generations of the dictionary have been created. At the time of recompression the dictionary version level referenced by the compressed file is also updated. If a compressed file is transferred to a machine that doesn't have the applicable version of the compression dictionary, then the two systems will synchronize all version changes of the dictionaries between each other. The systems will communicate their respective dictionary identifiers that include version information and each system (since it starts with a common global dictionary) will send deltas of versions from the level of the other system.

The commonly found patterns (byte chunk of varying lengths/words/bytes) keep getting concentrated upward in the subdictionary hierarchy toward the global dictionary. Less common patterns, specific to each individual file, are moved either into regional subdictionaries of file specific subdictionaries. Since the subdictionaries are “deltas” of the higher level structure they contain pointers to the original subdictionary that they differ from.

Since this is an active process, as each new file is analyzed, the hierarchical dictionary structure is usually modified. As the hierarchical dictionary structure is changed, previously compressed files would be recompressed, resulting in space savings. However, there is a trade-off between the savings in space and the cost of processing time for recompressing the previous files. In some instances, the compression saving is of such a small scale that the processing time to recompress previous files is excessive. In this case, the algorithm does not perform the change in the dictionary structure and merely uses the existing hierarchical structure.

Thus, according to the present invention, the new file is analyzed for byte chunk commonalties. These commonalties are compared to various subdictionaries to determine which subdictionary yields the best compression. The file may then either be compressed by that subdictionary, or use the subdictionary and create a file specific subdictionary that is a delta of the selected subdictionary.

In a preferred embodiment, the number of times that a subdictionary is referenced is counted. Subdictionaries with higher reference counts are more important and, over time, accessed first when analyzing new files. Thus, the algorithm is constantly “learning” from past analysis and evolving better dictionaries.

The algorithm can also segregate new incoming file by their origination location. That is, by business or business type. This allows the algorithm to immediately select region specific subdictionaries for initial analysis. Thus, when files are backed up, all common files are sorted by their attributes, their size, their date and time, file name, file extensions, and the like. The files that seem very similar based upon these attributes are matched together and analyzed to determine if they have common elements and be stored once with a notation that the files come from two different sources.

Additionally, the algorithm includes an analysis of the check sum values, size and CRC's. Thus, files with identical check sum values and size are compared byte by byte for commonalties. Since attributes, such as file name, date, and time, can be different on nearly identical or identical files, they are stored in a separate file with a point to the matching file. This way, the identical content is stored only once. This creates large data storage savings independent of the main compression process. In fact, this is an auxiliary compression process. This is especially useful for files, such as programs, that are distributed over a worldwide computer network where a plurality of individual, identical files with different names are located.

In one example there are two nearly identical files from different sources with small difference, typically a few words or phrases. The algorithm initially cannot determine that there are only slight differences. The algorithm tries to compress using existing dictionaries. The algorithm identifies all the other files associated with the selected dictionary/dictionary tree and looks for commonality of their maps, such that one may be a delta of the other. The new file will automatically be compared to the existing files to determine if the new file can be stored as a delta compression of an existing file. Since a delta will always be more compact than any standard compression, considerable storage savings can be accomplished in this manner. (If the difference between files is large, such as several paragraphs, then creating a file delta would not necessarily produce storage savings and traditional compression may be used.) Additionally, the delta, itself, may be compressed using standard compression techniques. Thus, the algorithm may elect to create a large delta and compress the large delta to produce storage savings. Existing dictionaries may be used, or new dictionaries may be created to compress deltas.

The totality of the dictionaries and compressions combined, or some subset of the totality, can be considered a file mass or superfile. Different superfiles may also be compressed by creating a new dictionary, thereby producing yet another storage savings.

There is a load balancing or weight balancing produced by the combination of above described algorithms according to the present invention. The dictionaries are weighted such that the more commonly referenced dictionaries get “heavier” and will be less and less prone to being delta'ed. Over time, the denser, important dictionaries start to gravitate towards the center of the global dictionary space and less important dictionaries are left out on the periphery.

This process is very similar to the biological process of evolution where most important and useful traits are favored over time and become more commonly occurring across the species. If the dictionary size is limited to a certain size due to optimization or other reasons then the less important dictionaries at the periphery would become first candidates for removal and hence mimic the process of extinction. The cost of extinction is high because all compressed files that refer to the peripheral sub dictionaries have to be updated and recompressed using the newer dictionaries. However it may not be too expensive since less important dictionaries are also referenced by a much-reduced number of files. In other words, dictionaries that go out of use because better more evolved dictionaries are getting employed are also made candidates of extinction or removal from the system.

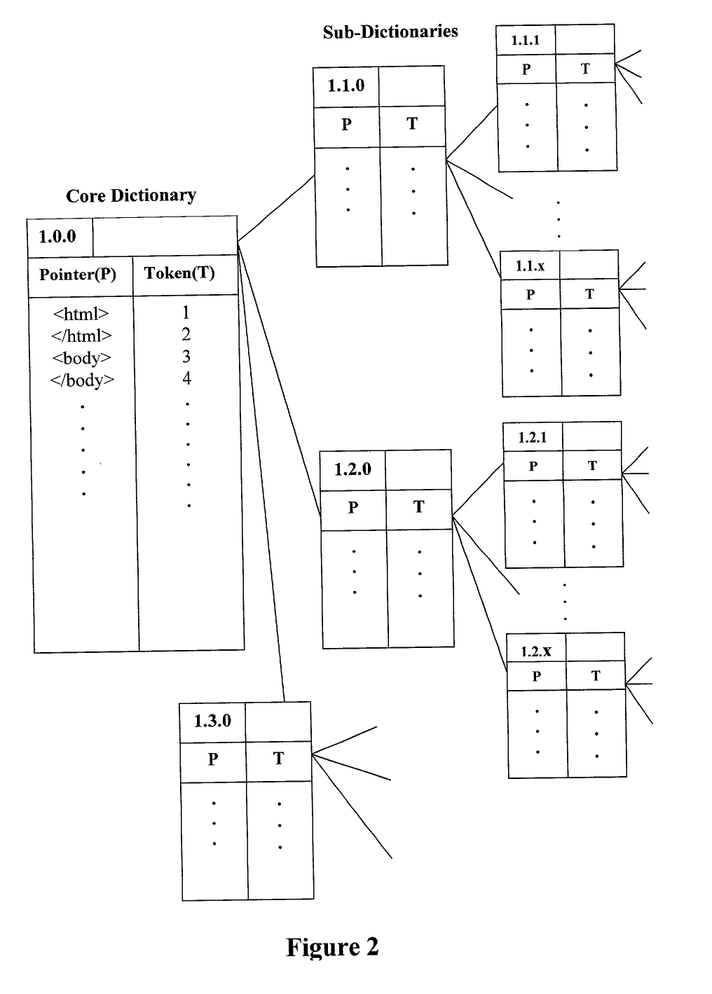

The most complex part of above process is the byte chunk matching or parsing performed by the encoder, as this necessitates searching through a potentially large dictionary. If the dictionary entries are structured as shown in FIG. 2, however, this process is considerably simplified. The structure shown in FIG. 2 is a tree representation of the series of byte chunk of varying lengths beginning with “t”; the initial entry in the dictionary would have an index number equal to the ordinal value of “t”.

To match the incoming byte chunk of varying length “the quick . . . ” the initial character “t” is read and the corresponding entry immediately located (it is equal to the ordinal value of “t”). The next character “h” is read and a search initiated among the dependents of the first entry (only 3 in this example). When the character is matched, the next input character is read and the process repeated. In this manner, the byte chunk of varying length “the” is rapidly located and when the encoder attempts to locate the next character, “ ”, it is immediately apparent that the byte chunk of varying length “the ” is not in the dictionary. The index value for the entry “the” is transmitted and the byte chunk of varying length matching process recommences with the character “ ”. This is based on principles that are well understood in the general field of sorting and searching algorithms (“The Art of Computer Programming,” vol. 3, Sorting and Searching, D. Knuth, Addison Wesley, 1968).

The dictionary of the present invention may be dynamically updated in a simple manner. When the situation described above occurs, i.e., byte chunk of varying length “the” has been matched, but byte chunk of varying length “the” +”” has not, the additional character “ ” may be added to the dictionary and linked to entry “the”. By this means, the dictionary above would now contain the byte chunk of varying length “the ” and would achieve improved compression the next time the byte chunk of varying length is encountered.

The two pass Mayne algorithm operates in the following way:

(a) Dictionary construction

Find the longest byte chunk of varying length of input symbols that matches a dictionary entry, call this the prefix byte chunk of varying length. Repeat the process and call this second matched byte chunk of varying length the suffix byte chunk of varying length. Append the suffix byte chunk of varying length to the prefix byte chunk of varying length, and add it to the dictionary. This process is repeated until the entire input data stream has been read. Each dictionary entry has an associated frequency count, which is incremented whenever it is used. When the encoder runs out of storage space, it finds the least frequently used dictionary entry and reuses it for the byte chunk of varying length or dictionary entry with a higher count frequency.

(b) Encoding

The process of finding the longest byte chunk of input symbols that matches a dictionary entry is repeated, however when a match is found, the index of the dictionary entry is transmitted. In the Mayne two pass schemes, the dictionary is not modified during encoding.

Referring now to the present invention, with small dictionaries, experience has shown that appending the complete byte chunk (as in Mayne, and Miller and Wegman) causes the dictionary to fill with long byte chunks of varying lengths that may not suit the data characteristics well. With large dictionaries (say 4096+entries) this is not likely to be the case. By appending the first two characters of the second byte chunk to the first, performance is improved considerably. The dictionary update process of the present invention therefore consists of appending N−1 characters if the suffix byte chunk is N characters in length, or one character if the suffix byte chunk is of length 1. In other words, for a suffix byte chunk of three characters the encoder determines a sequence constituted by only the first two characters of the suffix byte chunk and appends this sequence to the previously matched byte chunk.

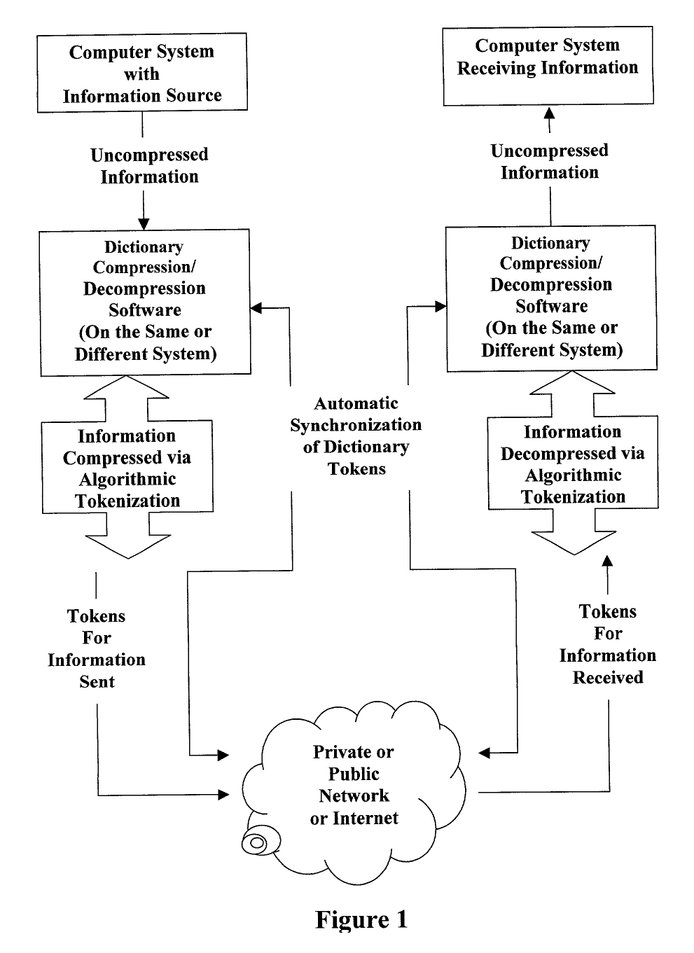

The data compression system of FIG. 1 comprises a dictionary 10 and an encoder 12 arranged to read characters of an input data stream, to search the dictionary 10 for the longest stored byte chunk that matches a current byte chunk in the data stream, and to update the dictionary 10. As an example, the encoder of 12 performs the following steps where the dictionary contains the byte chunk “mo”, “us” and the word “mouse” is to be encoded.

(i) Read “m” and the following character “o” giving the extended byte chunk of varying length “mo”.

(ii) Search in the dictionary for “mo” which is present, hence, let entry be the index number of the byte chunk of varying length “mo”.

(iii) Read the next character “u” which gives the extended byte chunk of varying length “mou”.

(iv) Search the dictionary for “mou” which is not present.

(v) Transmit entry the index number of byte chunk of varying length “mo”.

(vi) Reset the byte chunk of varying length to “u”, the unmatched character.

(vii) Read the next character “s” giving the byte chunk of varying length “us”.

(viii) Search the dictionary, and assign the number of the corresponding dictionary entry to entry.

(ix) Read the next character “e” giving the extended byte chunk of varying length “use”.

(x) Search the dictionary for “use”, which is not present.

(xi) Transmit entry the index number of byte chunk of varying length “us”.

(xii) Add the byte chunk of varying length “mo”+“us” to the dictionary.

(xiii) Start again with the unmatched “e.”

(xiv) Read the next character . . .

If the dictionary had contained the byte chunk of varying length “use,” then step (x) would have assigned the number of the corresponding dictionary entry, and step (xii) would still add the byte chunks “mo”+“us”, even though the matched byte chunk was “use.”Step (xiii) would relate to the unmatched character after “e.”

Many means for implementing the type of dictionary structure defined above are known. Two particular schemes will be outlined briefly.

(i) Tree structure U.S. patent application Ser. No. 623,809, now U.S. Pat. No. 5,153,591, on the modified Ziv-Lempel algorithm discusses a tree structure (“Use of Tree Structures for Processing Files,” E. H. Susenguth, CACM, vol. 6.5, pp. 272-79, 1963), suitable for this application. This tree structure has been shown to provide a sufficiently fast method for application in modems. The scheme uses a linked list to represent the alternative characters for a given position in a byte chunk, and occupies approximately 7 bytes per dictionary entry.

(ii) Hashing

The use of hashing or scatter storage to speed up searching has been known for many years. The principle is that a mathematical function is applied to the item to be located, in the present case a byte chunk, which generates an address. Ideally, there would be a one-to-one correspondence between stored items and hashed addresses, in which case searching would simply consist of applying the hashing function and looking up the appropriate entry. In practice, the same address may be generated by several different data sets, causing collision, and hence some searching is involved in locating the desired items.

The key factor in the present invention is that a specified searching technique does not need to be used. As long as the process for assigning new dictionary entries is well defined, an encoder using the tree technique can interwork with a decoder using hashing. The memory requirements are similar for both techniques.

The decoder receives codewords from the encoder, recovers the byte chunk characters represented by the codeword by using an equivalent tree structure to the encoder, and outputs them. It treats the decoded byte chunks as alternately prefix and suffix byte chunks, and updates its dictionary in the same way as the encoder.

In the present invention, the encoder's dictionary is updated after each suffix byte chunk is encoded, and the decoder performs a similar function. New dictionary entries are assigned sequentially until the dictionary is full. Thereafter, new entries are recovered in a manner described below.

The dictionary contains an initial character set, and a small number of dedicated codewords for control applications, the remainder of the dictionary space being allocated for byte chunk storage. The first entry assigned is the first dictionary entry following the control codewords. Each dictionary entry consists of a pointer and a character and is linked to a parent entry in the general form in FIG. 2. Creating a new entry consists of writing the character and appropriate link pointers into the memory locations allocated to the entry.

As the dictionary fills up, it is necessary to recover some storage in order that the encoder may be continually adapting to changes in the data stream. When the dictionary is full, entries are recovered by scanning the byte chunk of varying length storage area of the dictionary in simple sequential order. If an entry is a leaf, i.e., is the last character in a byte chunk of varying length, it is deleted. The search for the next entry to be deleted will begin with the entry after the last one recovered. The storage recovery process is invoked after a new entry has been created, rather than before, this prevents inadvertent deletion of the matched entry.

Not all data is compressible, and even compressible files can contain short periods of uncompressible data. It is desirable therefore that the data compression function can automatically detect loss of efficiency, and can revert to non-compressed or transparent operation. This should be done without affecting normal throughput if possible.

There are two modes of operation, transparent mode and compressed mode.

(I) TRANSPARENT MODE

(a) Encoder

The encoder accepts characters from a Digital Terminative Equipment (DTE) interface, and passes them on in uncompressed form. The normal encoding processing is, however, maintained, and the encoder dictionary updated, as described above. Thus, the encoder dictionary can be adapting to changing data characteristics even when in transparent mode.

(b) Decoder

The decoder accepts uncompressed characters from the encoder, passes the characters through to the DTE interface, and performs the equivalent byte chunk matching function. Thus, the decoder actually contains a copy of the encoder function.

(c) Transition from transparent mode

The encoder and decoder maintain a count of the number of characters processed, and the number of bits that these would have encoded in, if compression had been on. As both encoder and decoder perform the same operation of byte chunk matching, this is a simple process. After each dictionary update, the character count is tested. When the count exceeds a threshold the compression ratio is calculated. If the compression ratio is greater than 1, compression is turned On and the encoder and decoder enter the compressed mode.

(II) COMPRESSED MODE

(a) Encoder

The encoder employs the byte chunk matching process described above to compress the character stream read from the DTE interface, and sends the compressed data stream to the decoder.

(b) Decoder

The decoder employs the decoding process described above to recover character byte chunks from received codewords.

(c) Transition to transparent mode

The encoder arbitrarily tests its effectiveness, or the compressibility of the data stream, possibly using the test described above. When it appears that the effectiveness of the encoding process is impaired, the encoder transmits an explicit codeword to the decoder to indicate a transition to compressed mode. Data from that point on is sent in transparent form, until the test described in (i) indicates that the system should revert to compressed mode.

The encoder and decoder revert to prefix mode after switching to transparent mode.

A flush operation is provided to ensure that any data remaining in the encoder is transmitted. This is needed as there is a bit oriented element to the encoding and decoding process that is able to store fragments of one byte. The next data to be transmitted will therefore start on a byte boundary. When this operation is used, which can only be in compressed mode, an explicit codeword is sent to permit the decoder to realign its bit oriented process. This is used in the following way: When a DTE timeout or some similar condition occurs, it is necessary to terminate any byte chunk matching process and flush the encoder. The steps involved are: exit from byte chunk matching process, send codeword corresponding to partially matched byte chunk, send FLUSHED codeword and flush buffer.

At the end of a buffer, the flush process is not used, unless there is no more data to be sent. The effect of this is to allow codewords to cross frame boundaries.

The algorithm employed in the present invention is comparable in complexity to a modified Ziv-Lempel algorithm. Processing speed is very fast. Response time is minimized through the use of a timeout codeword, which permits the encoder to detect intermittent traffic (i.e., keyboard operation) and transmit a partially matched byte chunk. This mechanism does not interfere with operation under conditions of continuous data flow, when compression efficiency is maximized. The algorithm described above is ideally suited to the modem environment, as it provides a high degree of compression but may be implemented on a simple inexpensive microprocessor with a small amount of memory.

A range of implementations are possible, allowing flexibility to the manufacturer in terms of speed, performance and cost. This realizes the desire of some manufacturers to minimize implementation cost and of others to provide top performance. The algorithm is, however, well defined and it is thus possible to ensure compatibility between different implementations.

The preferred embodiment(s) of the invention is described above in the Drawings and Description of Preferred Embodiments. While these descriptions directly describe the above embodiments, it is understood that those skilled in the art may conceive modifications and/or variations to the specific embodiments shown and described herein. Any such modifications or variations that fall within the purview of this description are intended to be included therein as well. Unless specifically noted, it is the intention of the inventor that the words and phrases in the specification and claims be given the ordinary and accustomed meanings to those of ordinary skill in the applicable art(s). The foregoing description of a preferred embodiment and best mode of the invention known to the applicant at the time of filing the application has been presented and is intended for the purposes of illustration and description. It is not intended to be exhaustive or to limit the invention to the precise form disclosed, and many modifications and variations are possible in the light of the above teachings. The embodiment was chosen and described in order to best explain the principles of the invention and its practical application and to enable others skilled in the art to best utilize the invention in various embodiments and with various modifications as are suited to the particular use contemplated.

What is claimed is:

1. A data compression system comprising:
a. at least one dictionary structure comprising a one common global dictionary and at least one regional dictionary that is hierarchically inferior to the global dictionary, all dictionaries able to store bit chunks of variable lengths with an index for each of said bit chunks, the global dictionary is one that is accessible by a plurality of documents and contains the most commonly occurring bit chunks and ordering them according to frequency of occurrence, the regional dictionaries contain less commonly occurring words and phrases, but are also be accessible by multiple document files;
b. an algorithm for matching bit chunks of a data stream with bit chunks stored in either the common global dictionary or the at least one regional dictionary and for outputting the index of a dictionary entry of a matched bit chunk when a following character of the data stream does not match with the stored bit chunk;
c. said algorithm for matching bit chunks further being capable of determining the frequency of occurrence of the different stored bit chunks and able to dynamically replace and reorder the stored bit chunks between the common global dictionary and the at least one regional dictionary if a new bit chunk with a higher frequency count is determined.

2. The system according to claim 1, wherein the dictionary structure further comprises at least one sub-directory that is hierarchically inferior to the at least one regional dictionary.

3. The system according to claim 2, wherein the at least one regional dictionary is ordered as to business field of use.

4. The system according to claim 3, wherein the at least one regional dictionary is ordered as to business field of use.

5. The system according to claim 1, wherein the algorithm routinely scans across regional dictionaries to determine whether the different regional dictionaries have common patterns that can be concentrated upward in the hierarchical dictionary structure, further the differences between the different regional dictionaries being stored as a new smaller dictionary.

6. The system according to claim 2, wherein the algorithm routinely scans across regional or sub-dictionaries to determine whether the different regional or sub-dictionaries have common patterns that can be concentrated upward in the hierarchical dictionary structure, further the differences being stored as a new smaller subdictionary.

7. A method for compressing transmitted data comprising the steps of:
a. providing at least one dictionary structure comprising a one common global dictionary and at least one regional dictionary that is hierarchically inferior to the global dictionary, all dictionaries able to store bit chunks of variable lengths with an index for each of said bit chunk, the global dictionary is one that is accessible by a plurality of documents and contains the most commonly occurring bit chunks and ordering them according to frequency of occurrence, the regional dictionaries contain less commonly occurring words and phrases, but are also be accessible by multiple document files;
b. matching bit chunks of a data stream with bit chunks stored in either the common global dictionary or the at least one regional dictionary and for outputting the index of a dictionary entry of a matched bit chunk when a following character of the data stream does not match with the stored bit chunk;
c. determining the frequency of occurrence of the different stored bit chunks and dynamically replacing and reordering the stored bit chunks between the common global dictionary and the at least one regional dictionary if a new bit chunk with a higher frequency count is determined.

8. The method according to claim 7, wherein the dictionary structure further comprises at least one sub-directory that is hierarchically inferior to the at least one regional dictionary.

9. The method according to claim 8, wherein the at least one regional dictionary is ordered as to business field of use.

10. The method according to claim 9, wherein the at least one regional dictionary is ordered as to business field of use.

11. The method according to claim 7, further including the step of routinely scanning across regional dictionaries to determine whether the different regional dictionaries have common patterns that can be concentrated upward in the hierarchical dictionary structure, and further storing the differences between the different regional dictionaries as a new smaller dictionary.

12. The system according to claim 2, further including the step of routinely scanning across regional or sub-dictionaries to determine whether the different regional or sub-dictionaries have common patterns that can be concentrated upward in the hierarchical dictionary structure, and further storing the differences the different dictionaries as two new smaller subdictionaries.
